(19) United States
(12) Patent Application Publication
(10) Pub. No.: US 2006/0058400 A1
(43) Pub. Date: Mar. 16, 2006

(54) Method of producing homogeneous multicomponent dispersions and products derived from such dispersions

(75) Inventors: Helmut Schmidt, Saarbrucken-Gudingen (DE); Rudiger Nab, Riegelsberg (DE)

Correspondence Address: GREENBLUM & BERNSTEIN, P.L.C., 1950 ROLAND CLARKE PLACE, RESTON, VA, 20191, US

(73) Assignee: INSTITUT FUR NEUE MATERIALIEN gem. GmbH., Saarbruecken (DE)

(21) Appl. No.: 10/998,606

(22) Filed: Nov. 30, 2004

Related U.S. Application Data
(62) Division of application No. 10/313,635, filed on Dec. 5, 2002.
Application No. 10/313,635 is a continuation of application No. 08/716,324, filed on Oct. 4, 1996, now abandoned.

(30) Foreign Application Priority Data
Apr. 6, 1994 (DE) P 44 11 862 . 7

(51) Int. Cl. B01F 3/18; B01F 3/12

(52) U.S. Cl. 516/38

(57) ABSTRACT

A process for producing a dispersion of at least two types of finely divided particles. The process comprises providing at least a first type and a second type of finely divided particles with opposite surface charges and particle sizes which differ by a factor of at least three, and combining the particles and a dispersion medium and forming a substantially homogeneous dispersion of the at least two types of finely divided particles.

### CROSS-REFERENCE TO RELATED APPLICATIONS

The present application is a divisional of application Ser. No. 10/313,635, filed Dec. 5, 2002, which is a continuation of application Ser. No. 08/716,324, filed Oct. 4, 1996, which is a U.S. National Stage of International Application No. PCT/EP95/01263, filed Apr. 6, 1995, which claims priority of German Application No. P 44 11 862.7, filed Apr. 6, 1994. The disclosures of application Ser. No. 10/313,635, application Ser. No. 08/716,324 and International Application No. PCT/EP95/01263 are expressly incorporated by reference herein in their entireties.

### BACKGROUND OF THE INVENTION

1. Field of the Invention

The present invention relates to a process for producing homogeneous multicomponent dispersions and products derived therefrom, in particular a process for producing homogeneous multicomponent dispersions in which particles having a mean particle size of preferably not more than 100 μm are dispersed in an aqueous and/or organic medium

2. Description of the Related Art

In the production of ceramic materials, glasses and composite materials, the finely divided starting materials needed, for example the oxides, nitrides, borides, carbides and carbonitrides of Al, Si, Zr and Ti and the silicides, sulphides, arsenides, antimonides, selenides, phosphides and tellurides of alkali metals, alkaline earth metals, Sc, Y, Ti, Zr, Nb, Ta, Cr, Mo, W, Fe, Co, Ni and the lanthanides, are generally first processed to give a suspension (slip) of the starting materials in an aqueous or organic dispersion medium. After appropriate conditioning (adjustment of the rheology, solids content, dispersion state, etc.), the slip is either processed directly to give a green body using appropriate shaping methods or is first converted into a powder which is either pressed directly to form a green body or is redispersed and then shaped into a green body by appropriate shaping methods. Suitable shaping methods are tape casting, slip casting, pressure casting, electrophoresis, injection molding, freeze casting, centrifugation, gel casting, sedimentation, hot casting and freeze injection molding. The desired material or sintered body is finally obtained from the green body by sintering.

Sintering the usually ceramic starting materials to high density requires sintering aids, e.g. finely divided carbon (carbon black) and/or metals such as finely divided Al and B or materials selected from among the abovementioned starting materials. If these sintering aids are dispersed in aqueous or organic systems during preparation of the slip, different surface-chemical properties and/or very different particle sizes of the individual components result in difficulties such as an undesired formation of agglomerates and inhomogeneities in the multicomponent slip obtained. Naturally, such an inhomogeneity or agglomerate formation in the slip also has an unfavorable effect on the materials finally obtained therefrom.

### SUMMARY OF THE INVENTION

It is therefore an object of the present invention to provide a process for producing multicomponent dispersions of finely divided particles, in particular particles having a mean particle size of not more than 100 μm, preferably not more than 50 μm and in particular not more than 10 μm, which dispersions have the particles very homogeneously distributed and are therefore suitable for producing solid products, e.g. sintered bodies, having excellent homogeneity and advantageous properties resulting therefrom.

The present invention provides a process for producing homogeneous multicomponent dispersions in which the finely divided particles are dispersed in an aqueous and/or organic medium, wherein:
(a) if kinds of particles (having comparable or significantly different (mean) particle sizes) are present in which the groups X present on the surface of the kinds of particles are of poorly compatible or incompatible nature, at least one kind of particles is brought into contact with one or more species A which have at least one group B and at least one group Y, where under the conditions used the groups B form covalent, ionic or coordinate bonds with groups X present on the surface of this at least one kind of particles and the groups Y are groups which are compatible in terms of their nature with the surface groups of the other kind(s) of particles present in the dispersion; or
(b) if kinds of particles (having comparable or significantly different (mean) particle sizes) are present of which at least one kind of particles has groups X on the surface and at least one other kind of particles has groups W on the surface, these particles are brought into contact with one or more species D which have at least one group B and at least one group E, where under the conditions used the groups X and the groups B on the one hand and the groups E and the groups W on the other hand form covalent, ionic or coordinate bonds; or
(c) if kinds of particles having significantly different (mean) particle sizes are present, the particles are, separately as such or in dispersion, provided with opposite surface charges and the particles thus treated are then mixed.

### DETAILED DESCRIPTION OF THE INVENTION

The particles to be dispersed are preferably particles of materials which can be used in the production of ceramic materials, glasses and composites (e.g. ceramic/ceramic, glass/ceramic, glass/metal and ceramic/metal). Thus, they are, in particular, solid particles of inorganic or metallic origin such as carbon particles. The particles are particularly preferably particles of Si, B, Al, Ti, Zr, W, Mo, Cr and Zn and the (mixed) oxides, hydrated oxides, nitrides, carbides, silicides, borides and carbonitrides derived therefrom. Concrete examples are (anhydrous or hydrated) Al₂O₃, ZrO₂, Si₃N₄, mullite, cordierite, perovskites, e.g. BaTiO₃, PZT and PLZT, SiC, TiC, Ti(C,N), B₄C, BN, AlN, TiB₂, ZrB₂, ZrC, WC, MoSi₂, chromium carbide, aluminum carbide, ZnO, and carbon black. Of course, particles of other materials, for example these mentioned in the introduction, can also be used according to the invention. In general, the dispersions to be produced according to the invention contain particles of at least two different materials.

Furthermore, according to the invention, preference is given to using those materials comprising “nanosize” or “nanodisperse” or “submicron” particles or powders. In the present context, “nanosize” means an average particle size of not more than 100 nm, in particular not more than 50 nm and particularly preferably not more than 30 nm, with there being no specific lower particle size limit, but this being preferably 0.1 nm and in particular 1 nm. “Submicron” means, in the present context, a mean particle size of from greater than 100 nm to 1 μm.

Of course, it is also possible to use larger (kinds of) particles in the process of the invention, but the (mean) particle size should preferably not exceed 100 μm, in particular 50 μm and particularly preferably 10 μm.

The variants (a) to (c) of the process of the invention all serve to modify at least two kinds of particles (in general of different materials) which, for example owing to their different particle sizes and/or different surface properties, can be processed as such only with difficulty or not at all to give reasonably homogeneous dispersions, in such a way that their surfaces or surface properties are the same or at least very similar (variant (a)), that their surfaces attract electrostatically (variant (c)) or that they are, by means of their surface groups, chemically bound to one another (variant (b)).

In the following, the three variants of the process of the invention are discussed in more detail. In the interest of simplicity, the discussion will assume two-component systems, i.e. in each case there should be present only two kinds of particles which, either owing to their significantly different particle sizes and/or owing to their different surface properties, can be processed to give a reasonably homogeneous dispersion only subject to particular precautions, if at all. However, the present invention is not restricted to such two-component systems but it is also possible for there to be simultaneously present three, four, five, etc., kinds of particles which can also be similar or the same in terms of their particle size and/or surface properties, as long as there is present at least one kind of particles which cannot readily form homogeneous dispersions with the others for the abovementioned or other reasons. It is also possible, if more than two kinds of particles are present, to combine two or all of the variants (a) to (c) of the invention with one another.

The variant (a) of the process of the invention is, for example, an advantageous way of producing homogeneous dispersions when the two kinds of particles, which can be of comparable size, differ (significantly) in respect of the nature of the surface groups. This is the case, for example, when the surface groups X are polar or hydrophilic groups such as —OH, —COOH, etc., while the second kind of particles has surface groups which are nonpolar or hydrophobic, for example hydrocarbon radicals (e.g. —CH₃). Naturally, such a combination normally leads to dispersions in which the particles having polar surface groups X are preferentially situated adjacent to particles having similar surface properties, i.e. likewise having surface groups X, and the particles having nonpolar surface groups are preferably situated adjacent to particles having likewise nonpolar surface groups, i.e. not to a random distribution of the particles and thus to inhomogeneities.

According to the variant (a) of the invention, this situation can be altered in various ways such that the particles become very similar or even identical in respect of their surface properties and a random distribution of these in the dispersion is thereby made possible. All these possibilities have in common that one or both kinds of particles are modified on their surface in such a way that the surface groups of the particles are then very similar or even identical (e.g. all hydrophobic or all hydrophilic). This can be achieved by reacting the particles having the surface groups X with species (compounds) A which have, on the one hand, a group B which reacts with the said groups X to form a covalent, ionic or coordinate bond and, on the other hand, a group Y which is very similar or even identical in nature to the groups located on the surface of the other kind of particles. The end effect of this procedure is that the surface groups X are in practical terms replaced by surface groups Y which are (more) suitable for producing a homogeneous dispersion. However, it has to be realized that the groups X are not simply removed but are still always present in altered form (namely as part of a covalent, ionic or coordinate bond) and now merely serve as the anchoring point for the “new” surface groups Y. In the ideal case, the groups on the surface of the other kind of particles are likewise groups Y, although in many cases it is also sufficient if these surface groups are ones which, in terms of their nature, belong to the same class as the groups Y. For example, it is generally sufficient, when the surface groups of the other kind of particles are acid groups, for the group Y to likewise be an acid group (e.g. a carboxylic acid or sulfonic acid group). Of course, an analogous situation also applies in the case of, for example, basic, nonpolar or polar groups. Furthermore, the surface groups of the other kind of particles can be ones which have been fixed to the surface of this other kind of particles in a similar manner to the groups Y. In other words, it is of course also possible to modify the other kind of particles having, for example, surface groups X′ with species A′ having at least one group B′ and at least one group Y′ in such a way that in the end there are present surface groups Y′ which are the same as or at least have a comparable nature to the surface groups Y. However, for reasons of economy of effort, it is generally preferred to modify only one kind of particles in such a way that their surface groups are then compatible with the surface groups of the other kind of particles. However, it can also be the case that, for example, species A having a suitable group B and a suitable group Y are obtainable only with difficulty, if at all and it is therefore more advantageous to use (more readily obtainable) species A having at least one group B and at least one group V and to accordingly also modify the surface groups (e.g. Y) of the other kind of particles in such a way that they are compatible (or even identical) with the groups V.

The reaction of the kind of particles having the surface groups X with the species A can be carried out either in the presence of the other (possibly already surface-modified) kind of particles (e.g. in the dispersion medium) or separately therefrom (before production of the final dispersion). The latter variant has the advantage that it can also be used when it cannot be ruled out that, under the reaction conditions used, the surface groups of the other kind of particles will also react with the groups B or even the groups Y or the other kind of particles can lead to some form of interference with the reaction between the groups X and B.

The procedure in the above reaction or surface modification is comprehensively described for the example of nanosize particles in DE-A4212633, the full scope of the disclosure of which is hereby incorporated by reference. If the surface modification of the one kind of particles is carried out in the absence of the other kind of particles, the dispersion medium used can subsequently be removed in a customary manner (e.g. by filtration), which can be followed by washing and drying of the particles. This procedure also has the advantage that no residual (i.e. unreacted) species A are present in the homogeneous dispersion to be produced later. The particles thus modified can then be dispersed together with the unmodified, or likewise previously modified in an appropriate manner, other kind of particles in the actual dispersion medium so as to produce a homogeneous dispersion.

Concrete examples of species A and suitable dispersion media, etc., are indicated further below.

The variant (b) of the process of the invention is particularly advantageous when kinds of particles having significantly different particle sizes are to be dispersed together, but can also be advantageously employed for the dispersion of kinds of particles having comparable sizes. Nevertheless, this variant (b) will be explained in more detail for the case of the joint dispersion of (significantly) larger particles having surface groups X (e.g. particles in the submicron or micron range) and (significantly) smaller particles having surface groups W (e.g. nanosize powders). The variant (b) differs from the variant (a) essentially only in that the group Y of the species A, which in the case of the variant (a) has to be compatible only with the surface groups of the other kind of particles, is replaced by the group E which can react with the surface groups W of the other kind of particles to form a covalent, ionic or coordinate bond (similar to the case of the groups X and B). Although in the case of the variant (b) too, the reaction between the groups X and B with the groups E and W can be carried out simultaneously (in the final dispersion medium), preference is given to carrying out these reactions in succession. Particular preference is given to first reacting the larger particles having the surface groups X with the species D (as in the case of the variant (a) with the species A), then removing the dispersion medium used and washing and, if desired, drying the particles obtained. Subsequently, the particles thus surface-modified can be combined and reacted with the smaller particles having surface groups W, which is advantageously carried out in the dispersion medium to be used for the final dispersion, so as to avoid again having to remove the reaction medium.

Both in the variant (a) and in the variant (b), the species A or D do not necessarily have to have only one group B and one group Y or E, but, on the contrary, in some cases it can be advantageous if these species are anchored, for example, via two or even three groups B or E to the particles having the surface groups X or W, at least as long as it is ensured that such multiple anchoring is sterically possible.

The process according to alternative (b) just indicated for the case of larger particles having surface groups X and smaller particles having surface groups W can be regarded essentially as a chemical coating of the larger particles with the smaller particles, with the species D serving as coupling agent. In comparison, the process according to variant (c) of the process of the invention can be described as electrostatic coating of larger particles with smaller particles. In this variant, it has to be ensured, first and foremost, that the signs of the surface charges of the two kinds of particles to be dispersed (having significantly different particle sizes) are different, so that, owing to their opposite surface charges, the larger particles attract the smaller particles and vice versa. Naturally, this process increases in efficiency with increasing surface charges of the participating particles. In the present context, the expression “significantly different particle size” means, in particular, particles whose (mean) particle sizes differ by at least a factor of 3, preferably at least a factor of 5 and more preferably at least a factor of 10.

The charging of the surfaces of the participating particles can be carried out in various ways. For example, one or both kinds of particles can be (separately) electrostatically charged and then added together or in succession to the dispersion medium.

According to a particularly preferred embodiment of the variant (c), the larger and the smaller particles are first dispersed separately and the dispersions thus prepared are combined and mixed, with the pH values of the separate dispersions being selected such that, both in these dispersions and also in the resulting dispersion (after combining), the zeta potentials of the kinds of particles have a different sign and, in particular, have as high as possible a positive value or as high as possible a negative value.

The zeta potential is a measure of the number of surface charges generated. It is pH-dependent and is either positive or negative in relation to the isoelectric point of the respective material. In other words, the higher the zeta potential the higher the charging of the particles and the higher the force of attraction for particles of opposite charge.

The formation of negative or positive surface charges is preferably effected or aided by addition of an acid or base. Acids suitable for this purpose are, for example, inorganic acids such as HCl, HNO₃, H₃PO₄ and H₂SO₄ and also organic carboxylic acids such as acetic acid, propionic acid, citric acid, succinic acid, oxalic acid and benzoic acid. Suitable bases are, for example, NH₃, NaOH, KOH, Ca(OH)₂ and also primary, secondary and tertiary aliphatic and aromatic amines and tetraalkylammonium hydroxides. However, it is a prerequisite for this embodiment of the variant (c) of the process of the invention that the particles originally used have surface groups which are (sufficiently) negatively or positively charged depending on the pH selected. This requirement is not always met by particles which have not been surface-modified. In particular, it has to be taken into account that two kinds of particles to be combined not only have to each have suitable surface groups which bear positive or negative charges depending on the pH, but that these surface groups also have to have opposite (and preferably large) surface charges at the desired pH of the final dispersion so as to ensure the presence of strong forces of attraction. Thus, in the case of the variant (c) it can also be necessary to modify at least one of the two kinds of particles on the surface in such a way as to result in particles having surface groups which together with the other kind of particles fulfill the above-mentioned conditions. Hence, for example in the case of larger particles having surface groups X which in combination with the other kind of particles would not be suitable for the pH-dependent electrostatic coating process (e.g. because the zeta potentials of the two kinds of particles would have the same sign at the desired or any pH), the procedure can be to react these particles first with species A (as described above in variant (a)), where the group Y of the species A is one which has a suitable zeta potential at the desired pH.

If the other kind of particles has a zeta potential having the “correct” sign but a relatively low value, the second kind of particles can also be appropriately modified so as then to have surface groups which result in a zeta potential having still the same sign but a higher value at the desired pH.

If, in the case of the variant (c), one of the kinds of particles is already present in a suitable (charged) form, it is of course only necessary for the other kind of particles to be appropriately charged, possibly after prior surface modification (as described above).

The species which can be used for the purposes of surface modification in the above variants (a) to (c) of the process of the invention are described in more detail below.

In the case of the species A and D, the groups B and Y or B and E are, for example, joined to one another by means of a single (covalent) bond or (preferably) by means of a hydrocarbon radical. This hydrocarbon radical can include one or more hetero atoms such as halogen, O, S and N, either as part of the basic structure and/or merely bound thereto (particularly in the case of halogen). The hydrocarbon radical can be a saturated or unsaturated, aliphatic, cycloaliphatic or aromatic hydrocarbon radical or a combination thereof and this radical preferably has a molecular weight not exceeding 500, in particular 300 and particularly preferably 200. Particular preference is given to using connecting groups whose basic structure comprises not more than 30, in particular not more than 20 and particularly preferably not more than 10, atoms (carbon atoms plus hetero atoms). Concrete examples of connecting groups are C₂₋₂₀-(cyclo)alk(en)ylene groups such as ethylene, propylene, butylene, (cyclo)pentylene and (cyclo)hexylene, C₅₋₁₂-(hetero)arylene such as phenylene, naphthylene and pyridylene, and also combinations of one or more of these groups.

The nature of the groups B, E and Y in the species A and D of course depends on the nature of the groups present on the surfaces of the particles to be dispersed. However, preferred groups B, E and Y are those of the formulae —COT, —SO₂T, —POT₂, —OPOT₂, —OH, —NHR¹ and —CO—CHR¹—CO—, where T are halogen (F, Cl, Br or I), —OCO—, —OR¹ and —NR¹₂ (and can be identical or different) and R¹ are identical or different and are H or C₁₋₈-alkyl (preferably C₁₋₄-alkyl), where Y can also be a group of the formula —CR²₃ in which R² are identical or different and are hydrogen, halogen Cm particular F and Cl) and C₁₋₈-alkyl (preferably C₁₋₄-alkyl) and one group R² can also be OR³ or SR³ (R³=C₁₋₈-alkyl or C₆₋₁₂-aryl). The additional meanings for Y are explained by the fact that Y is a group which does not have to react with any other group to form a covalent, ionic or coordinate bond but only has to be similar to or the same as the groups present on the surfaces of the other kind of particles to be dispersed, where these groups can also be hydrophobic (nonpolar) groups.

Concrete examples of preferred species A and D are the following, which must, however, not be regarded as restricting the present invention:
monocarboxylic and polycarboxylic acids having from 2 to 12 carbon atoms, for example acetic acid, propionic acid, butyric acid, pentanoic acid, hexanoic acid, acrylic acid, methacrylic acid, crotonic acid, citric acid, adipic acid, succinic acid, glutaric acid, oxalic acid, maleic acid, fumaric acid, itaconic acid, toluenesulfonic acid, trifluoroacetic acid, stearic acid, trioxadecanoic acid and the corresponding anhydrides (such as acetic anhydride, propionic anhydride, succinic anhydride and maleic anhydride), halides (such as acetyl chloride, propanoyl chloride, butanoyl chloride and valeryl chloride), esters (e.g. ethyl acetate) and amides (e.g. acetamide);
monoamines and polyamines such as those of the general formula R₃₋ₙNHₙ, where n=0, 1 or 2 and the radicals R are, independently of one another, alkyl groups having from 1 to 12, in particular from 1 to 6 and particularly preferably from 1 to 4, carbon atoms (e.g. methyl, ethyl, n- and i-propyl and butyl) and alkylene (in particular ethylene and propylene) mines, for example ethylenediamine, propylenediamine and diethylenetriamine;
β-dicarbonyl compounds having from 4 to 12, in particular from 5 to 8, carbon atoms, for example acetylacetone, 2,4-hexanedione, 3,5-heptanedione, acetoacetic acid and C₁₋₄-alkyl acetoacetates; and
compounds having at least two different functional groups, for example alanine, arginine, asparagine, aspartic acid and other amino acids, and also betaine, EDTA, guanidineacetic acid, guanidinepropionic acid, guanidinebutyric acid, azodicarbonamide, 8-hydroxyquinoline, 2,6-pyridine-dicarboxylic acid, methacrylonitrile, diaminomaleonitrile, acetimide, guanine and guanosine and also guanidine carbonate, guanidine nitrate and guanidinobenzimidazole.

Other preferred species A and D for use in the present invention are those in which at least one of the groups B and Y or B and E have the formula -MZₙR₃₋ₙ or —AlZₘR₂₋ₘ, where M is Si, Ti or Zr, Z is a group which is reactive with a surface group X or W, R are groups which are nonreactive with a surface group X or W and are identical or different groups if (3-n) is equal to 2, n is 1, 2 or 3, preferably 1 or 2, and m is 1 or 2. Of course, it is also possible to use corresponding groups in which M or Al is replaced by Sc, Y, La, Ce, Nd, Nb, Ta, Mo, W, B, etc.

Among the above groups, particular preference is given to those containing Si. Concrete examples of corresponding species are the following: mercaptopropyltrimethoxysilane, 3-(trimethoxysilyl)propyl methacrylate, 3-(triethoxysilyl)propylsuccinic anhydride, cyanoethyltrimethoxysilane, 3-thiocyanatopropyltriethoxysilane, 3-(2-aminoethylamino)-propyltrimethoxysilane, 3-aminopropyltriethoxysilane, 7-oct-1-enyltrimethoxysilane, phenyltrinethoxy-silane, n-butyltrimethoxysilane, n-octyltrimethoxysilane, n-decyltrimethoxysilane, n-dodecyltriethoxysilane, n-hexadecyltrimnethoxysilane, n-octadecyltrimethoxysilane, n-octadecyltrichlorosilane, dichloromethyl-vinylsilane, diethoxymethylvinylsilane, dimethyloctadecylmethoxysilane, tert-butyldimethylchlorosilane-methyldisilazane, diethoxydimethylsilane, diethyl trimethylsilyl phosphite, 2-(diphenylmethylsilyl)ethanol, diphenylsilanediol, ethyl(diphenylmethylsilyl) acetate, ethyl-2,2,5,5-tetramethyl-1,2,5-azadisilolidine 1-acetate, ethyltriethoxysilane, hydroxytriphenylsilane, trimethylethoxysilane, trimethylsilyl acetate, allyldimethylchlorosilane, (3-cyanopropyl)dimethylchlorosilane and vinyltriethoxysilane.

For the (separate) surface modification, the particles concerned are usually dispersed in a suitable solvent (dispersion medium) which is inert under the reaction conditions, for example water, an aliphatic or aromatic hydrocarbon such as hexane or toluene or an ether such as diethyl ether, tetrahydropyran or THF or a polar, protic or aprotic solvent (for example an alcohol such as methanol ethanol n- and i-propanol and butanol a ketone such as acetone and butanone, an ester such as ethyl acetate, an amide such as dimethyl-acetamide and dimethylformamide, a sulfoxide or sulfone such as sulfolane and dimethyl sulfoxide) and reacted with the surface-modifier (for example species A or species D) in an appropriate manner (possibly at elevated temperature and/or in the presence of a catalyst).

Subsequently, the dispersion medium can be removed and the surface-modified material can be, if desired, washed and dried and redispersed in the final dispersion medium (aqueous and/or organic). Examples of suitable dispersion media are the solvents already mentioned above as examples of suitable media for the surface modification.

The dispersion medium used preferably has a boiling point which makes it possible to remove the same without difficulty by distillation (possibly under reduced pressure). Preference is given to solvents having a boiling point below 200° C., in particular below 150° C., although the use of higher-boiling liquids (e.g. having boiling points >350° C.) is of course also possible.

In the case of the production of ceramic materials, glasses and composites, the content of (final) dispersion medium is generally from 10 to 90% by volume, preferably from 15 to 85% by volume and in particular from 20 to 80% by volume. The remainder of the dispersion is composed of (modified) starting powders, inorganic and/or organic processing aids and possibly free modifiers (e.g. species A or species D) still present.

The homogeneous dispersion obtained according to the invention can either be further processed as such (see below) or the dispersion medium is completely or partially removed (e.g. to a desired solids concentration). A particularly preferred method of removing the dispersion medium (in particular when this comprises water) is freeze drying in its various embodiments (e.g. freeze spray drying).

The homogeneous dispersion or the dry homogeneous multicomponent mixture of ceramic powders obtained by the process of the invention can then be further processed to produce green bodies or sintered bodies. The homogeneous ceramic slip obtainable according to the invention can, for example, be shaped directly to give a green body by means of the shaping methods mentioned in the introduction, e.g. by tape casting, slip casting, pressure casting, injection molding, electrophoresis, gel casting, freeze casting, freeze injection molding or centrifugation.

Alternatively, as mentioned above, a sinterable powder can be obtained from the slip, for example by filtration, evaporation of the dispersion medium, spray drying or freeze drying. This is then either pressed as such to form a green body or else the sinterable powder is redispersed, preferably using a surfactant as dispersing aid, and this suspension is then processed by one of the abovementioned shaping processes to form a green body. In this embodiment, suitable dispersing aids are, for example, inorganic acids such as HCl, HNO₃ and H₃PO₄; organic acids such as acetic acid, propionic acid, citric acid and succinic acid; inorganic bases such as NaOH, KOH and Ca(OH)₂; and organic bases such as primary, secondary and tertiary amines and also tetraalkylammonium hydroxides; organic polyelectrolytes such as polyacrylic acid, polymethacrylic acid, polysulfonic acids, polycarboxylic acids, salts (e.g. Na or NH₄) of these compounds, N,N-dialkylimidazolines and N-alkylpyridinium salts; or nonionic surfactants such as polyethylene oxides, fatty acid alkylolamides, sucrose-fatty acid esters, trialkylamine oxides and fatty acid esters of polyhydroxy compounds.

The green body can finally be sintered at customary temperatures, which in most cases are in the range from 1000 to 2500° C., to give a sintered body. However, in certain cases the usable sintering temperatures can also be significantly lower, e.g. 250° C. or less.

The following examples serve to illustrate the present invention, but without limiting it.

### EXAMPLE 1

### Production of Al₂O₃/SiC Dispersions According to Variant (a)

(a) Surface Modification of SiC Powders in Toluene

A 500 ml three-neck round-bottom flask fitted with precision glass stirrer, reflux condenser and drying tube was charged with 70 ml of toluene whose water content had been determined by means of Karl Fischer titration. To ensure reproducible results, it was made a condition that the water content of the toluene used had to be within a range of 0.10±0.04% by weight

1.27 g of aminoethylaminopropyltrimethoxysilane or 1.74 g of 3-(triethoxysilylpropyl)succinic anhydride were dissolved in a further 30 ml of toluene and added while stirring to the three-neck round-bottom flask. After addition of 50 g of SiC powder (UF 45, Lonza), the suspension was held at 130° C. for 5 hours. The modified SiC powder was then filtered off and washed three times with 100 ml each time of toluene. After drying for 16 hours at 120° C. in a drying oven, the powder was milled for production of the slip.

An analogous experimental procedure was also used for the modification of Si and B₄C. For 50 g of each of the powders, use was made of 2.46 g (B₄C) or 0.68 g (Si) of 3-(triethoxysilylpropyl)succinic anhydride or 1.80 g (B₄C) or 0.49 g (Si) of aminoethylaminopropyltrimethoxysilane.

(b) Combining Al₂O₃ and SiC

2 g of a double-comb polymer having acid functional groups (Dapral EN 1469, ICI) were dissolved in 100 ml of distilled water and then 5.6 g of the SiC powder surface-modified with aminoethylaminopropyltrimethoxysilane as described in (a) were added and dispersed by means of ultrasound. This was followed by the addition of 128 g of Al₂O₃ powder (CS 400 M, Martinswerk). The resulting suspension was predispersed by means of ultrasound, while the final homogenization of the suspension was carried out by milling for 2 hours in a stirred ball mill (1000 rpm).

Since the surface-chemical properties of SiC were, as a result of the previous modification of this, essentially the same as those of Al₂O₃, a homogeneous, stable two-component suspension having a solids content of 35% by volume and an SiC content of 5% by volume could be produced. The viscosity of the suspension was 12 mPa.s at a shear rate of 200 s⁻¹. Shaped bodies having relative green densities of 59-62% were produced from this slip by slip casting in plaster moulds, and these shaped bodies were sintered at 1800° C. in a flowing nitrogen atmosphere to give sintered bodies having a relative density of above 98%. The sintered bodies had a homogeneous distribution of the SiC particles. The mean grain size of the sintered bodies was between 2 and 2.5 μm, while strengths between 650 and 700 mPa were measured.

Surprisingly, the pressureless densification at 1800° C. thus leads to very high densities while maintaining an extremely fine microstructure. This can only be attributed to a significantly improved homogeneity of the slip.

### EXAMPLE 2

### Chemical Coating of SiC with Nanosize Carbon Black According to Variant (b)

3.75 g of carbon black having surface carboxyl groups (EW 200) were placed in one liter of toluene. While stirring, 150 g of the SiC powder modified with aminoethylaminopropyltrimethoxysilane as described in Example 1 (a) were added. After addition was complete, the suspension was reacted for 5 hours at 130° C. using a water separator. After this reaction time, the modified powder was filtered off, washed three times with 100 ml each time of toluene and dried at 110° C. for 16 hours in a drying oven. This gave a visually homogeneous, deep black powder.

### EXAMPLE 3

### Production of Al₂O₃/TiN Slips Containing Nanosize TiN by Electrostatic Coating According to Variant (c)

Al₂O₃ slips containing between 1 and 5% by volume of TiN were produced by a procedure similar to Example 1. The production of homogeneous Al₂O₃/TiN slips by electrostatic coating is based on the zeta potentials of Al₂O₃ and TiN which have opposite signs in the pH range between 3 and 8. The composite slip was produced in the following manner:

(a) Production of an Aqueous Al₂O₃ Suspension

To produce an aqueous Al₂O₃ suspension (Al₂O₃ powder AKP 50 from Sumitomo), the corresponding amount of water was initially charged and a weighed amount of Al₂O₃ powder was slowly added while stirring continuously. The pH was maintained at values between 3 and 4 by addition of HCL. The suspension was meanwhile treated with ultrasound in order to achieve effective dispersion.

(b) Production of a Nanodisperse TiN Suspension

The procedure was similar to (a), with the TiN used being a nanosize powder surface-modified by a method similar to Example 1(a). The pH of the suspension was kept between 3 and 9 by means of tetrabutylammonium hydroxide.

(c) Production of the Final Dispersion

The Al₂O₃ and TiN suspensions produced in (a) and (b) above were mixed together while stirring continuously and treated with ultrasound. After mixing the two suspensions, the pH of the composite slip was between 4 and 5.

(d) Further Processing

The composite slip was stabilized by addition of a nonionic protective colloid in a concentration of 2% by weight (based on Al₂O₃ and TiN) (Tween® 80, ICI).

The amounts of dispersion medium (water), Al₂O₃ and TiN and also the ratio Al₂O₃/TiN were such that slips containing from 1 to 5% by volume of nanosize TiN and from 20 to 30% by volume of solids were obtained (see Table 1).

The resulting slips can be used directly for shaping processes such as slip casting or pressure slip casting or, after being concentrated, can be processed to give extrusion compositions. Green bodies produced by slip casting had an extremely homogeneous distribution of the nanodisperse TiN particles in the Al₂O₃ matrix.

TABLE 1
Numerical example for the production of 20 or 30% strength by volume Al₂O₃/TiN
composite slips having TiN contents of from 1 to 5% by volume (for 100 ml of slip)

| | Solids content [% by volume] | | | |
|---|---|---|---|---|
| TiN content | 20 | | 30 | |
| [% by volume] | Al₂O₃ suspension | TiN suspension | Al₂O₃ suspension | TiN suspension |
| 1.0 | 78 g Al₂O₃ in | 1 g TiN in | 118 g Al₂O₃ in | 1.56 g TiN in |
| | 50 ml H₂O, | 30 ml H₂O, | 60 ml H₂O, | 10 ml H₂O, |
| | pH = 3-4 | pH = 8-9 | pH = 3-4 | pH = 8-9 |
| Protective colloid | 1.58 g | | 2.40 g | |
| 2.5 | 77 g Al₂O₃ in | 2.6 g TiN in | 116 g Al₂O₃ in | 3.90 g TiN in |
| | 50 ml H₂O, | 30 ml H₂O, | 60 ml H₂O, | 10 ml H₂O, |
| | pH = 3-4 | pH = 8-9 | pH = 3-4 | pH = 8-9 |
| Protective colloid | 1.59 g | | 2.41 g | |
| 5.0 | 75 g Al₂O₃ in | 5.21 g TiN in | 113 g Al₂O₃ in | 7.8 g TiN in |
| | 50 ml H₂O, | 30 ml H₂O, | 60 ml H₂O, | 10 ml H₂O, |
| | pH = 3-4 | pH = 8-9 | pH = 3-4 | pH = 8-9 |
| Protective colloid | 1.60 g | | 2.42 g | |

### EXAMPLE 4

### Production of Homogeneous Al₂O₃/SiC Composite Slips by Electrostatic Coating According to Variant (c)

Owing to different surface-chemical properties, the Al₂O₃ and SiC particles in aqueous suspensions have surface charges with opposite signs in the pH range between 3 and 8. Thus, the prerequisites for electrostatic coating of Al₂O₃ with SiC (or vice versa) are met in this pH range.

Based on this principle, aqueous Al₂O₃ slips having SiC contents between 5 and 15% by volume were produced in the following manner:

(a) Production of an Aqueous Al₂O₃ Suspension

To produce an aqueous Al₂O₃ suspension (Al₂O₃ powder CS 400 m, Martinswerk, d₅₀˜400 nm), the appropriate amount of deionized water was initially charged and a weighed amount of Al₂O₃ powder was added while stirring continuously. The pH was maintained at values between 3 and 4 by addition of HCl. The suspension was meanwhile treated with ultrasound so as to achieve effective dispersion.

(b) Production of the Aqueous SiC Suspension

The procedure was similar to (a), with the SiC powder used being the powder surface-modified according to Example 1(a) (TF 45, Lonza; mean particle size 90 nm). The pH of the suspension was maintained between 6 and 7 by addition of dilute ammonia.

(c) Production of the Final Dispersion

The suspensions produced as described in (a) and (b) above were mixed while stirring continuously. After the reaction, the pH of the resulting slip was between 4 and 5.

(d) Further Processing

The composite slip was stabilized by addition of a nonionic protective colloid (Tween® 80, ICI) in a concentration of 2% by weight based on total solids.

The slips produced are summarized in Table 2.

On the slips containing 5% by volume of SiC and having solids contents of 30% by volume, viscosities of 16 mPa.s were measured at shear rates of 200 s⁻. Slip casting of this slip in plaster moulds gave green bodies having green densities between 0.56 and 0.58 which had a very homogeneous SiC distribution in the Al₂O₃ matrix. These green bodies were subjected to pressureless sintering at 1800° C. in a flowing nitrogen atmosphere to form sintered bodies having relative densities of over 98% on which flexural strengths of over 700 MPa were measured. The homogeneous SiC distribution in the green bodies led, after sintering, to a microstructure having mean grain sizes between 2 and 3 μm, which was very fine for an Al₂O₃ powder having mean starting particle sizes of 400 nm and for a sintering temperature of 1800° C.

TABLE 2
Numerical example for the production of 20 or 30% strength by volume Al₂O₃/SiC
composite slips having SiC contents between 5 and 15% by volume (for 100 ml of slip)

| | Solids content [% by volume] | | | |
|---|---|---|---|---|
| SiC content | 20 | | 30 | |
| [% by volume] | Al₂O₃ suspension | SiC suspension | Al₂O₃ suspension | SiC suspension |
| 5.0 | 75.6 g Al₂O₃ in | 3.2 g SiC in | 113 g Al₂O₃ in | 4.8 g SiC in |
| | 70 ml H₂O, | 10 ml H₂O, | 60 ml H₂O, | 10 ml H₂O, |
| | pH = 3-4 | pH = 6-7 | pH = 3-4 | pH = 6-7 |
| Protective colloid | 1.57 g | | 2.35 g | |
| 10 | 71.4 g Al₂O₃ in | 6.4 g SiC in | 107 g Al₂O₃ in | 9.6 g SiC in |
| | 70 ml H₂O, | 10 ml H₂O, | 60 ml H₂O, | 10 ml H₂O, |
| | pH = 3-4 | pH = 6-7 | pH = 3-4 | pH = 6-7 |
| Protective colloid | 1.55 g | | 2.33 g | |
| 15 | 67.5 g Al₂O₃ in | 9.69 g SiC in | 101.2 g Al₂O₃ in | 14.4 g SiC in |
| | 60 ml H₂O, | 20 ml H₂O, | 55 ml H₂O, | 15 ml H₂O, |
| | pH = 3-4 | pH = 6-7 | pH = 3-4 | pH = 6-7 |
| Protective colloid | 1.54 g | | 2.31 g | |

The following examples further illustrate the surface modification of particles suitable for producing ceramic materials.

### EXAMPLE 5

### Surface Modification of Carbon Black

50 g of carbon black were placed in a 2 l three-neck round-bottom flask fitted with precision glass stirrer, reflux condenser and drying tube. To this carbon black were added 1.3 l of toluene whose water content had been determined prior to the modification reaction by means of Karl-Fischer titration. To ensure reproducible results, it was made a condition that the water content of the toluene used had to be within a range of 0.10±0.04% by weight

45.4 g of aminoethylaminopropylsuccinic anhydride were dissolved in a further 0.2 l of toluene and added while stirring to the three-neck round-bottom flask. The resulting suspension was held at 130° C. for 5 hours, whereupon the surface-modified carbon black was filtered off and washed three times with 100 ml each time of toluene. After drying for 16 hours at 120° C. in a drying oven, the powder was milled.

### EXAMPLE 6

### Surface Modification of B₄C

A 500 ml three-neck round-bottom flask fitted with precision glass stirrer, reflux condenser and drying tube was charged with 70 ml of toluene whose water content had been determined prior to the modification reaction by means of Karl-Fischer titration. To ensure reproducible results, it was made a condition that the water content of the toluene used had to be within a range of 0.10±0.04% by weight

1.80 g of aminoethylaminopropyltrimethoxysilane or 2.46 g of 3-(triethoxysilylpropyl)succinic anhydride were dissolved in a further 30 ml of toluene and added while stirring to the three-neck round-bottom flask. After addition of 50 g of B₄C, the suspension was reacted for 5 hours at 130° C., whereupon the modified powder was filtered off and washed three times with 100 ml each time of toluene. After drying for 16 hours at 120° C. in a drying oven, the powder was milled for the production of the slip.

### EXAMPLE 7

### Surface Modification of n-TiN Powder

For the modification of n-TiN powder, 200 ml of H₂O/methanol mixtures (1:1) were placed in a three-neck flask fitted with reflux condenser and drying tube and 0.7 g of guanidinepropionic acid was added thereto. After the guanidinepropionic acid had dissolved while heating and stirring, 10 g of n-TiN powder were added in portions while stirring, whereupon the mixture was heated under reflux (90° C.) for 4 hours. The hot suspension was then filtered through a suction filter (pore width: 3-6 μm) and the residue was washed thoroughly with the H₂O/ethanol mixture, whereupon the filter cake was dried for 10 hours at 90° C. The dried powder could be redispersed to a mean particle size of down to 40 nm.

What is claimed is:

1. A process for producing a dispersion of at least two types of finely divided particles, the process comprising:
(a) providing at least a first type and a second type of the at least two types of finely divided particles, the at least first and second types of particles having opposite surface charges and particle sizes which differ by a factor of at least three;
(b) combining the particles and a dispersion medium and forming a substantially homogeneous dispersion of the at least two types of finely divided particles.

2. The process of claim 1, wherein only the first and second types of particles are present.

3. The process of claim 1, wherein more than two types of particles are present.

4. The process of claim 1, wherein the dispersion medium comprises an aqueous medium.

5. The process of claim 1, wherein the dispersion medium comprises an organic medium.

6. The process of claim 1, wherein the dispersion medium comprises a mixed aqueous/organic medium.

7. The process of claim 1, where the particles comprise solid particles of inorganic origin.

8. The process of claim 1, where the particles comprise solid particles of metallic origin.

9. The process of claim 1, wherein the particles comprise carbon particles.

10. The process of claim 1, wherein the particles comprise particles of substances which are usable in the production of ceramic materials.

11. The process of claim 1, wherein the particles comprise one or more particles of at least one of Si, B, Al, Ti, Zr, W, Mo, Cr and Zn, and oxides, mixed oxides, hydrated oxides, nitrides, carbides, suicides, borides, and carbonitrides thereof.

12. The process of claim 11, wherein the particles comprise at least one of Al₂O₃, TiN and SiC.

13. The process of claim 1 wherein the particles comprise particles having a size of from 0.1 nm to 10 μm.

14. The process of claim 13, wherein at least one of the types of particles has a mean particle size not exceeding 100 nm.

15. The process of claim 12, wherein at least one of the types of particles has a mean particle size not exceeding 50 nm.

16. The process of claim 15, wherein at least one of the types of particles has a mean particle size not exceeding 30 nm.

17. The process of claim 13, wherein the at least first and second types of particles have particle sizes which differ by a factor of at least five.

18. The process of claim 1, wherein the at least first and second types of particles have particle sizes which differ by a factor of at least ten.

19. The process of claim 1, where the process comprises dispersing at least two types of particles in separate media to form separate dispersions and combining the thus-formed separate dispersions to form the substantially homogeneous dispersion of the at least two types of particles.

20. The process of claim 19, where pH values of the separate dispersions are selected such that both in the separate dispersions and in the substantially homogeneous dispersion zeta potentials of the at least two types of particles have different signs.

21. The process of claim 1, wherein at least one of the first and second types of finely divided particles are surface-modified to provide first and second types of particles having opposite surface charges.

22. The process of claim 1, wherein charged surface groups of at least one of the first and second types of finely divided particles are reacted with a species which provides different charged surface groups.

23. The process of claim 1, wherein the process further comprises:
(c) removing the dispersion medium from the dispersion to produce a mixture of particles which is substantially free of the dispersion medium.

24. The process of claim 23, wherein the process further comprises:
(d) at least one of washing, drying, and calcining the thus-formed mixture of particles.

25. A process for producing a dispersion of at least two types of finely divided particles, the process comprising:
(a) providing at least a first type and a second type of the at least two types of finely divided particles, the at least first and second types of particles having opposite surface charges and particle sizes which differ by a factor of at least five;
(b) combining the particles and a dispersion medium and forming a substantially homogeneous dispersion of the at least two types of finely divided particles;
wherein at least one of the types of particles has a mean particle size not exceeding 100 nm and the particles comprise one or more particles of at least one of carbon, Si, B, Al, Ti, Zr, W, Mo, Cr and Zn, and oxides, mixed oxides, hydrated oxides, nitrides, carbides, silicides, borides, and carbonitrides thereof.

26. A substantially homogeneous dispersion of at least two types of finely divided particles, wherein the dispersion is obtainable by the process of claim 1.

27. A substantially homogeneous dispersion of at least two types of finely divided particles, wherein the dispersion comprises a liquid dispersion medium and at least a first type and a second type of the at least two types of finely divided particles, the at least first and second types of particles having opposite surface charges and particle sizes which differ by a factor of at least three.

28. The dispersion of claim 27, wherein zeta potentials of the at least two types of particles have different signs.

29. The dispersion of claim 27, wherein the particles comprise particles having a size of from 0.1 nm to 10 μm.

30. The dispersion of claim 29, wherein at least one of the types of particles has a mean particle size not exceeding 100 nm.

31. The dispersion of claim 27, wherein at least one of the types of particles has a mean particle size not exceeding 50 nm.

32. The dispersion of claim 27, wherein the at least first and second types of particles have particle sizes which differ by a factor of at least five.

33. The dispersion of claim 30, wherein the at least first and second types of particles have particle sizes which differ by a factor of at least ten.
